(19) United States
(12) Patent Application Publication
(10) Pub. No.: US 2006/0019041 A1
(43) Pub. Date: Jan. 26, 2006

(54) Tile with simulated antique brick appearance, method for the fabrication of tiles with simulated antique brick appearance

(76) Inventors: Julie Good-Kruger, Quarryville, PA (US); Timothy Kruger, Quarryville, PA (US)

Correspondence Address: CHERSKOV & FLAYNIK, THE CIVIC OPERA BUILDING, 20 NORTH WACKER DRIVE, SUITE 1447, CHICAGO, IL, 60606, US

(21) Appl. No.: 11/146,911

(22) Filed: Jun. 7, 2005

Related U.S. Application Data
(60) Provisional application No. 60/577,648, filed on Jun. 7, 2004.

(51) Int. Cl. A01N 1/00

(52) U.S. Cl. 428/15; 264/220

(57) ABSTRACT

Clay tiles having the appearance of antique bricks are manufactured by making a latex casting of the surface of a model antique brick; producing a clay model by pressing an oven-hardening clay into the casting, then stretching it slightly to allow for clay shrinkage when the clay is fired; firing the clay model; pouring a liquid resin layer over the clay model and heat-curing the resin layer so as to form a flexible resin mold; placing the resin mold it in a box with a removable bottom plate, said box configured to a predetermined tile size; applying a release agent to inside surfaces of the box and to the resin mold; sprinkling wood ash or clay powder on to the resin mold; pressing clay into the box and tapping it to fill the box; removing the clay form from the box; peeling off the resin mold from the clay form; and drying and firing the clay form.

This patent application claims the benefits of U.S. Provisional Application No. 60/577,648, filed on Jun. 7, 2004.

### BACKGROUND OF THE INVENTION

1. Field of the Invention

The present invention relates to the field of ceramic tiles, and more particularly, the present invention relates to a tile simulating an antique brick appearance and to a method for manufacturing such a tile.

2. Description of the Prior art

The production of clay bricks dates back to antiquity, and quite often, builders who engage in the rehabilitation of old buildings require modern materials that simulate the appearance of antique bricks. Other builders commonly seek to construct modern buildings with tiles that have an antique brick look. For both applications builders prefer that these modern bricks be inexpensive and easy to install. Antique bricks often have irregular edges and this makes mass-production thereof very difficult for they cannot be stacked on an edge during the drying process. Also, it makes laying of such bricks very difficult, especially when compared to the laying of tiles of standard dimensions.

Several inventors have introduced modern mass-production techniques in the fabrication of tiles that have an antique appearance. U.S. Pat. No. 4,178,340 (Hyytien) teaches a method of coloring the sides of the bricks so as to give them a mottled appearance on one side and a streaked effect on the opposite side.

U.S. Pat. No. 4,229,156 (Hyytien) teaches another method of coloring the sides of the bricks so as to give them a mottled appearance.

U.S. Pat. No. 4,495,132 (Johnson) teaches a method of fabrication that utilizes pre-fired bricks and requires three conveyor belts and two rotating tables and while a pair of canted rollers impart an irregular shape to the longitudinal edges of the bricks.

A need exists in the art for tiles that have the appearance of antique bricks (“antique brick tiles”) in that they have a distinctive coloring and an irregular surface topography, but that have standard rectangular dimensions and approximately uniform appearance, similar to that of a pre-selected antique brick.

### SUMMARY OF THE INVENTION

It is an object of the present invention to provide a tile that simulates the appearance of an antique brick and that overcomes many of the disadvantages of the prior art.

It is a further object of the present invention to provide a method to produce an antique brick tile. A feature of the invention is that it facilitates replication of an antique brick selected by a modern day customer. An advantage of the invention is that a modern tile is produced that has a surface identical to that of a specific antique brick, but the beneficial configuration of modern-day tiles.

Yet another object of the present invention is to provide tiles that have the appearance of various antique bricks. A feature of the invention is that it provides a method that comprises one by one coloring of tiles with different wood ashes or clay powders that duplicates the appearance of the surface of an antique brick. An advantage of the invention is that modern tiles are produced using a single flexible mold to yield tiles with slightly different surface relief and coloring.

Still another object of the present invention is to provide tiles that have the appearance of various antique bricks but have rectangular edges. A feature of the invention is that it provides a method for producing tiles wherein a relief with irregular edges is juxtaposed on a rectangular substrate. An advantage of the invention is that modern tiles are produced with an irregular surface relief identical to that of an antique brick but with a standard rectangular base facilitating stacking drying and installation of the tiles.

Briefly, the invention provides for a method for molding a simulated antique brick tile, the method comprising making a latex casting of the surface of a model antique brick; producing a clay model by pressing an oven-hardening clay into the casting, then stretching it slightly to allow for clay shrinkage when the clay is fired; firing the clay model; pouring a liquid resin layer over the clay model and heat-curing the resin layer so as to form a resin mold; placing the resin mold it in a box with a removable bottom plate, said box configured to a predetermined tile size; applying a release agent to inside surfaces of the box and to the resin mold; sprinkling a coloring agent on to the resin mold; pressing clay into the box and tapping it to fill the box; removing the clay form from the box; peeling off the resin mold from the clay form; and drying and firing the clay form.

Also provided is a simulated antique brick tile comprising a relief with irregular edges juxtaposed on a rectangular base substrate.

### DESCRIPTION OF THE DRAWING

The invention together with the above and other objects and advantages will best be understood from the following detailed description of the preferred embodiment of the invention shown in the accompanying drawing, wherein:

FIG. 1 is a schematic diagram of an antique brick tile, in accordance with features of the present invention; and

FIG. 2 is a schematic diagram of an antique brick tile making process, in accordance with features of the present invention.

### DETAILED DESCRIPTION OF THE INVENTION

The present invention provides modern tiles that simulate the appearance of antique bricks (designated as ‘brick tiles’) and discloses a method for manufacturing such modern brick tiles. The invented antique brick tiles replicate of the surface structure of antique bricks used as models, but with each tile having a different coloring and slightly different surface topography.

Briefly, the present invention introduces a method for the fabrication of bricks with an antique appearance comprising the steps of making a casting of a specific antique brick; from this casting making a clay model of the antique brick; from this clay model making a flexible mold; and from the flexible mold making the desired antique brick tile.

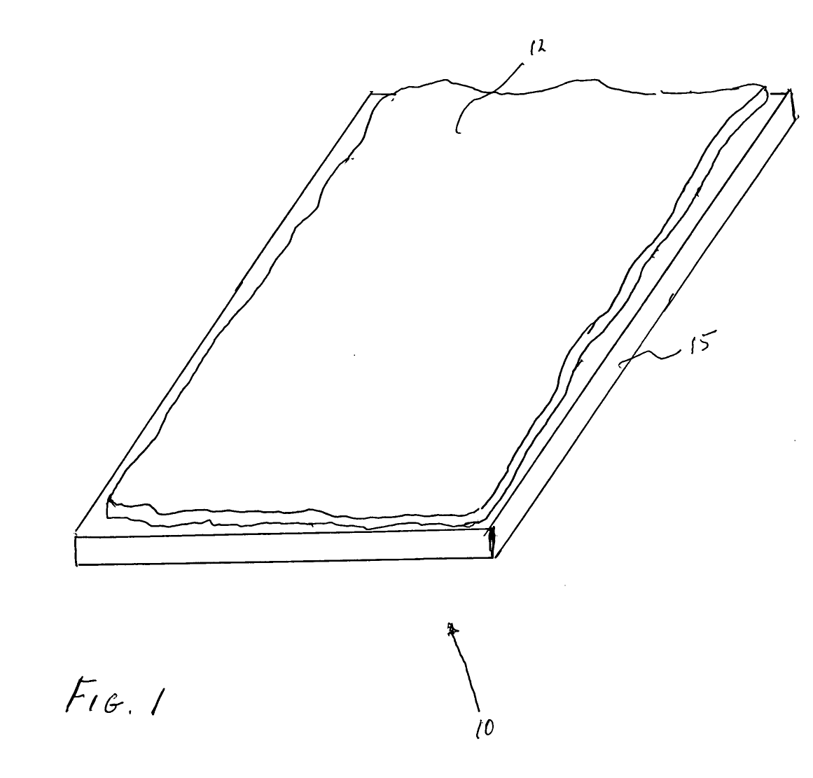

As shown in FIG. 1, an invented antique brick tile 10 comprises a relief 12 with irregular edges juxtaposed on a standard-size rectangular base substrate 15. The standard rectangular base facilitates stacking and drying of the tiles as well as their installation. After the tiles are laid, grout is applied so as to cover the rectangular base and display only the relief for each tile.

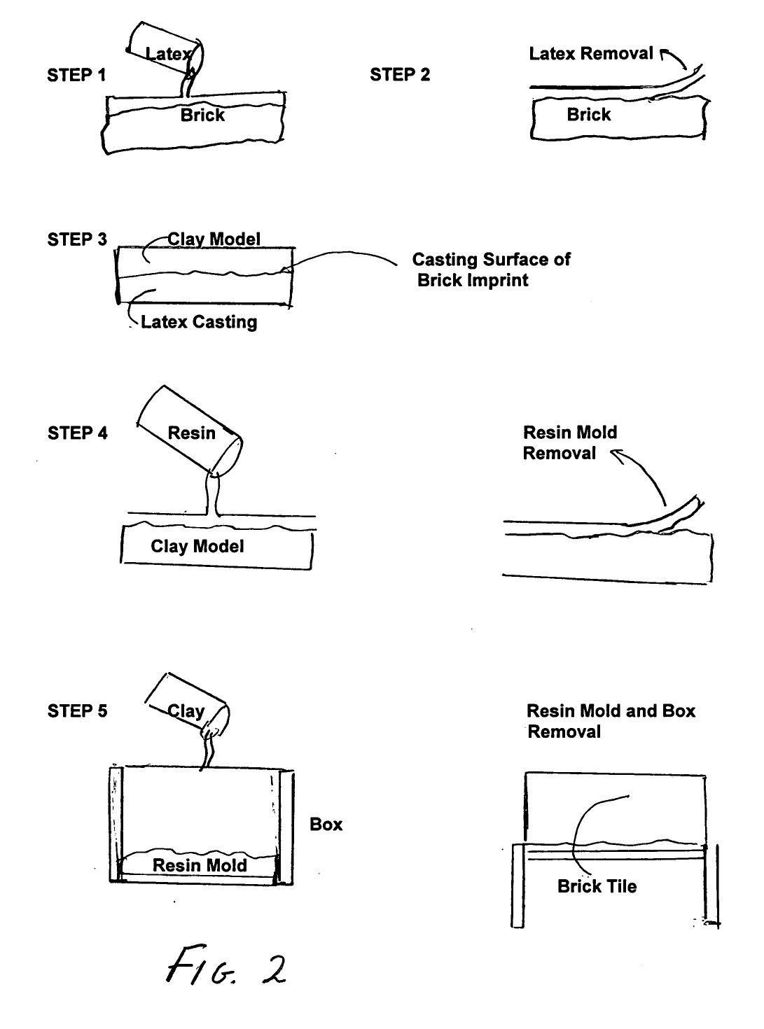

The method, as schematically illustrated in FIG. 2, comprises the following general steps:

1. Applying latex (or a similar substance) to the surface of an antique brick.

2. Making a casting (such as from latex) of the specific antique brick.

3. From this casting making a clay model of the antique brick.

4. From this clay model making a flexible mold of the clay model.

5. From the flexible mold making the desired antique brick tile.

First an antique brick is selected. Then a casting of the surface of a model antique brick is made by using commercially available liquid latex solution such as that supplied by the Polytech Co. of Easton, Pa. The latex is brushed on the surface in layers. As each coat dries, another coat is applied. Typically five to seven layers are applied. The casting is allowed to air-dry, and then peeled off the surface of the model antique brick. This casting forms the ⅛″ top of the tile.

In a third step, clay model is produced by hand-pressing an oven-hardening clay into the casting, then stretching it slightly to allow for clay shrinkage when the clay is fired at 250 degrees Fahrenheit for 10 minutes. Over-hardening clays are commercially available, including that from Polyform Products Company, Inc, Elk Grove Village, Ill. Sand “Standard Clay” from Pittsburgh, Pa. The clay model is allowed to harden in an oven, and then affixed to an horizontal steel plate by sealing the periphery of the model to the steel plate with the same clay material as the one used for the model. This seal prevents the molding material from seeping underneath the clay model. This creates a tidy edge. A frame is then placed around the clay model, the frame comprised of plastic, steel, ceramic or some other nonstick surface.

A flexible mold is formed by pouring a liquid resin (such as polyurethane) layer over the clay model and then heat-curing the resin layer. Aside from resin, other water resistant and reversibly deformable material can be utilized. Suitable polyurethane resin may be obtained from Air Products and Chemicals of Allentown, Pa. Typically the resin is cured at 240 degrees Fahrenheit for 16 hours, after which time the resin mold reaches between 80% and 90% of its eventual stiffness. Then one peels the resin mold from the clay model and allows the resin mold to air-cure to substantially 100% in approximately two weeks. The final polyurethane mold has a base thickness of around 0.25 in and a side thickness between approximately 1/16 and ⅛ in, depending on the surface configuration.

The mold for a modern tile simulating the appearance of an antique brick is produced as follows. The resin flexible mold is placed concave face up in a rigid box with a removable bottom plate, said box being configured to a standard tile size, such as 8 in by 4 in (or other sizes such as 2 in by 8 in or 4 in by 2 in) and providing rectangular walls ¼ in high.

The sides of the box and of the resin mold are brushed with a release agent such as kerosene or motor oil. Then wood ash or clay powder is sprinkled in the resin mold. Different wood ashes or clay powders produce tiles of different surface color or patina.

A clay brick tile is produced by pressing clay into the box and tapping it with a paddle or otherwise to fill the box. Excess clay is cut from the top of the box to form the bottom of the invented tile. Then one pushes up the bottom plate up through the box, so that the bottom of the plate is level with the top upper rim of the box. Then the tile is picked up and flipped over on to a flat metal surface such as a spatula. The resin mold is peeled off from the tile and set aside. The tile is placed onto a drying rack and air-dried for about three days and then dried in a kiln at 200 degrees Fahrenheit for 4 hours. Finally they are fired to between 2250 and 2400 degrees Fahrenheit (depending on the type of clay) until they vitrify.

The method is repeated as removable bottom plate is placed back into the box and the resin mold is placed again on the bottom plate, and the subsequent steps are repeated so as to produce another tile. The flexibility of the resin mold ensures that no two tiles would be identical. As such, the flexible mold provides a means for varying the topography of the tiles produced by the same mold by varying the pressure applied as the mold is filled with clay. Also, using surface appearance modifiers such as different wood ashes and different clays one can produce a very large variety of tiles.

The flexibility of resin molds has several other advantages:
1) Higher fidelity reproduction of surface features such as striations, pits, and undercuts as one can peel off the mold without damaging these features.
2) A resin mold does not absorb water, while often used plaster molds do, so that they cannot be used more than 3 to 5 times before being left to dry for a day.
3) Individual tile fabrication using a plaster mold takes longer because the mold absorbs moisture from the clay. The clay tile must remain in the mold until the clay sides begin to dry and separate from the plaster: otherwise the clay will adhere to the plaster as one tries to pull the mold away.

The resin mold/rigid box can be used for a myriad of sculptured designs, yielding the same advantages as those enumerated supra in conjunction with brick tiles.

While the invention has been described with reference to details of the illustrated embodiments, these details are not intended to limit the scope of the invention as defined in the appended claims.

The embodiment of the invention in which an exclusive property or privilege is claimed is defined as follows:

1. A method for molding a simulated antique brick tile comprising:
a) making a casting of a surface of a pre-existing antique brick;
b) producing a clay model by pressing an oven-hardening clay into the casting;
c) firing the clay model;
d) forming a resin mold of the clay model; and
e) making a brick from said mold.

2. A method for molding a simulated antique brick tile comprising:
a) making a latex casting of the surface of a pre-selected antique brick;
b) producing a clay model by pressing an oven-hardening clay into the casting, then stretching it slightly to allow for clay shrinkage when the clay is fired;
c) firing the clay model;
d) pouring a liquid resin layer over the clay model and heat-curing the resin layer so as to form a resin mold; p1 e) placing the resin mold it in a box with a removable bottom plate, said box configured to a predetermined tile size;
f) applying a release agent to inside surfaces of the box and to the resin mold;
g) sprinkling a coloring agent on to the resin mold;
h) pressing clay into the box and tapping it to fill the box;
i) removing the clay form from the box;
j) peeling off the resin mold from the clay form; and
k) drying and firing the clay form.

3. The method as recited in claim 2 wherein said resin mold is flexible.

4. The method as recited in claim 2 wherein said resin is polyurethane.

5. The method as recited in claim 2 wherein steps e) through k) are repeated so as to produce another tile with a slightly different surface topography and color.

6. The method as recited in claim 2 wherein said coloring agent is wood ash.

7. The method as recited in claim 2 wherein said coloring agent is clay powder.

8. A simulated antique brick tile comprising a relief with irregular edges juxtaposed on a rectangular base substrate.
